(19) United States
(12) Patent Application Publication
(10) Pub. No.: US 2025/0337044 A1
(43) Pub. Date: Oct. 30, 2025

(54) TRACTION BATTERY PACK THERMAL MANAGEMENT ASSEMBLY AND THERMAL MANAGEMENT METHOD

(71) Applicant: Ford Global Technologies, LLC, Dearborn, MI (US)

(72) Inventor: Xiaogang Zhang, Novi, MI (US)

(21) Appl. No.: 18/649,894

(22) Filed: Apr. 29, 2024

(51) Int. Cl. H01M 10/6567; B60K 11/04; B60L 50/64; H01M 10/613; H01M 10/625; H01M 10/647; H01M 10/6561

(52) U.S. Cl. CPC H01M 10/6567; B60K 11/04; B60L 50/64; H01M 10/613; H01M 10/625; H01M 10/647; H01M 10/6561; H01M 2220/20

(57) ABSTRACT

A traction battery pack assembly includes an enclosure assembly providing an interior, and a first cell stack housed within the interior. The first cell stack includes first battery cells having first terminals. A second cell stack is housed within the interior. The second cell stack includes second battery cells having second terminals. A first coolant is within the interior. The first coolant directly contacts the first terminals of the first battery cells within the first cell stack and second terminals of the second battery cells within the second cell stack. A second coolant manages thermal energy within the interior. The second coolant is a different type of coolant than the first coolant.

### TECHNICAL FIELD

This disclosure details exemplary methods and assemblies that utilize more than one type of coolant to help to manage thermal energy within a battery pack having a plurality of cell stacks.

### BACKGROUND

Electrified vehicles differ from conventional motor vehicles because electrified vehicles include a drivetrain having one or more electric machines. The electric machines can drive the electrified vehicles instead of, or in addition to, an internal combustion engine. A traction battery pack assembly can power the electric machines. Coolant can be moved through the traction battery pack to help manage thermal energy within the traction battery pack.

### SUMMARY

In some aspects, the techniques described herein relate to a traction battery pack assembly, including: an enclosure assembly providing an interior; a first cell stack housed within the interior, the first cell stack including a plurality of first battery cells having first terminals; a second cell stack housed within the interior, the second cell stack including a plurality of second battery cells having second terminals; a first coolant within the interior, the first coolant directly contacting the first terminals of the plurality of first battery cells within the first cell stack and second terminals of the plurality of second battery cells within the second cell stack; and a second coolant that manages thermal energy within the interior, the second coolant a different type of coolant than the first coolant.

In some aspects, the techniques described herein relate to a traction battery pack assembly, wherein the first coolant is less conductive than the second coolant.

In some aspects, the techniques described herein relate to a traction battery pack assembly, wherein the first terminals and the second terminals face each other within the interior.

In some aspects, the techniques described herein relate to a traction battery pack assembly, wherein the first coolant is a dielectric coolant.

In some aspects, the techniques described herein relate to a traction battery pack assembly, wherein the first coolant is a liquid coolant, wherein the second coolant is a liquid coolant.

In some aspects, the techniques described herein relate to a traction battery pack assembly, wherein the first coolant is air and the second coolant is a liquid coolant.

In some aspects, the techniques described herein relate to a traction battery pack assembly, further including a sealing system within the interior, the sealing system separating the interior into a first volume that contains the first coolant and at least one different, second volume that contains the second coolant.

In some aspects, the techniques described herein relate to a traction battery pack assembly, wherein the plurality of first battery cells and the plurality of second battery cells are configured to vent into the first volume.

In some aspects, the techniques described herein relate to a traction battery pack assembly, wherein the sealing system includes at least one first sealing ring circumscribing one or more of the first battery cells and at least one second sealing ring circumscribing one or more of the second battery cells.

In some aspects, the techniques described herein relate to a traction battery pack assembly, wherein the at least one first sealing ring seals an interface between a surface of at least one of the first battery cells and the enclosure assembly.

In some aspects, the techniques described herein relate to a method of managing thermal energy levels within a battery pack, including: positioning first terminals of at least one first cell stack within a first volume that is within an interior of a battery pack; positioning second terminals of at least one second cell stack within the first volume that is within the interior of the battery pack; circulating a first coolant through the first volume to manage thermal energy; and circulating a second coolant through at least one second volume within the interior of the battery pack, the second coolant a different type of coolant than the first coolant.

In some aspects, the techniques described herein relate to a method, wherein the first coolant is less conductive than the second coolant.

In some aspects, the techniques described herein relate to a method, wherein the first coolant is a liquid dielectric.

In some aspects, the techniques described herein relate to a method, wherein the first coolant is air.

In some aspects, the techniques described herein relate to a method, further including sealing the first volume from the at least one second volume to block the first coolant from entering the at least one second volume, and to block the second coolant from entering the first volume.

In some aspects, the techniques described herein relate to a method, wherein the first terminals and the second terminals face each other within the interior of the battery pack.

In some aspects, the techniques described herein relate to a method, wherein the first volume is separate and distinct from the at least one second volume.

In some aspects, the techniques described herein relate to a method, wherein components of the battery pack that are configured as electrical conductors are disposed within the first volume.

In some aspects, the techniques described herein relate to a method, further including venting the at least one first cell stack and the at least one second cell stack into the first volume.

The embodiments, examples and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

### BRIEF DESCRIPTION OF THE FIGURES

The various features and advantages of the disclosed examples will become apparent to those skilled in the art from the detailed description. The figures that accompany the detailed description can be briefly described as follows:

FIG. 1 illustrates a side view of an electrified vehicle having a battery pack.

FIG. 2 illustrates a perspective and partially expanded view of the battery pack of FIG. 1 according to an exemplary aspect of the present disclosure.

FIG. 3 illustrates a perspective view of a battery cell from the battery pack of FIG. 2.

FIG. 4 illustrates a perspective view of the battery pack of FIG. 1.

FIG. 5 shows a flow of an example method of managing thermal energy in the battery pack FIGS. 2-5.

### DETAILED DESCRIPTION

An immersion thermal management system can be used to manage thermal energy in a battery pack.

This disclosure is directed toward an immersion thermal management system that uses different types of coolant. In an example, a coolant, such as a dielectric liquid, can be used to manage thermal energy in some areas. Another type of coolant, perhaps a water/glycol mix, is used to manage thermal energy in other areas.

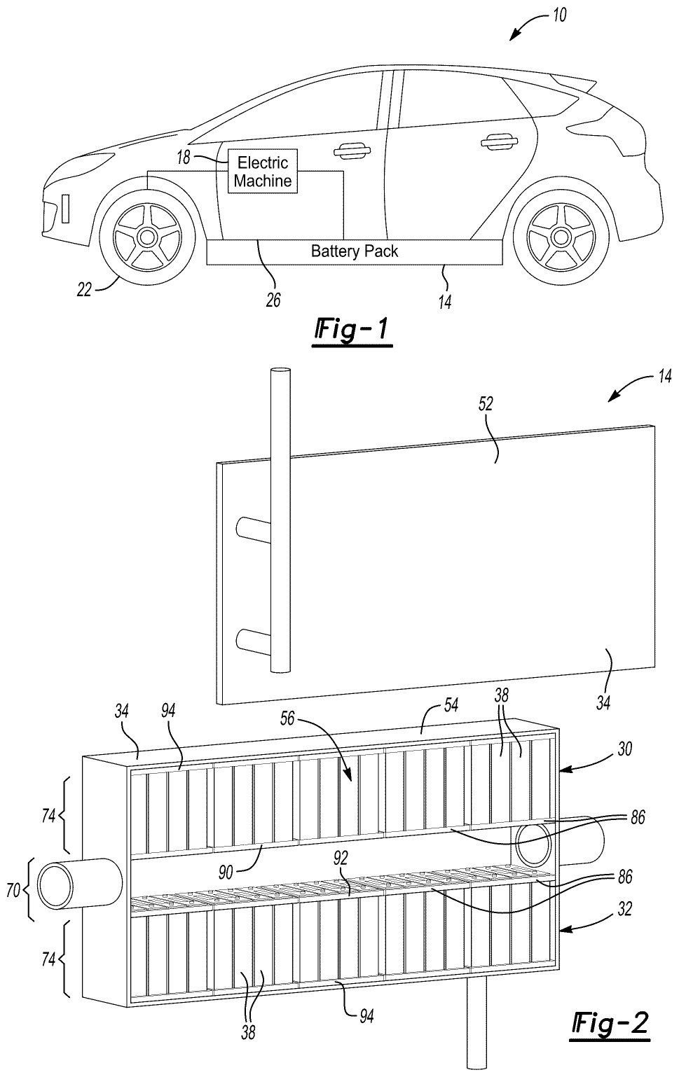

With reference to FIGS. 1, an electrified vehicle 10 includes a traction battery pack 14, an electric machine 18, and wheels 22. The traction battery pack 14 powers an electric machine 18, which can convert electrical power to mechanical power to drive the wheels 22. The traction battery pack 14 can be a relatively high-voltage battery.

The traction battery pack 14 is, in the exemplary embodiment, secured to an underbody 26 of the electrified vehicle 10. The traction battery pack 14 could be located elsewhere on the electrified vehicle 10 in other examples.

The electrified vehicle 10 is an all-electric vehicle. In other examples, the electrified vehicle 10 is a hybrid electric vehicle, which selectively drives wheels using torque provided by an internal combustion engine instead of, or in addition to, an electric machine. Generally, the electrified vehicle 10 could be any type of vehicle having a traction battery pack.

Although the different examples have the specific components shown in the illustrations, embodiments of this disclosure are not limited to those particular combinations. It is possible to use some of the components or features from one of the examples in combination with features or components from another one of the examples. In addition, the various figures accompanying this disclosure are not necessarily to scale, and some features may be exaggerated or minimized to show certain details of a particular component or arrangement.

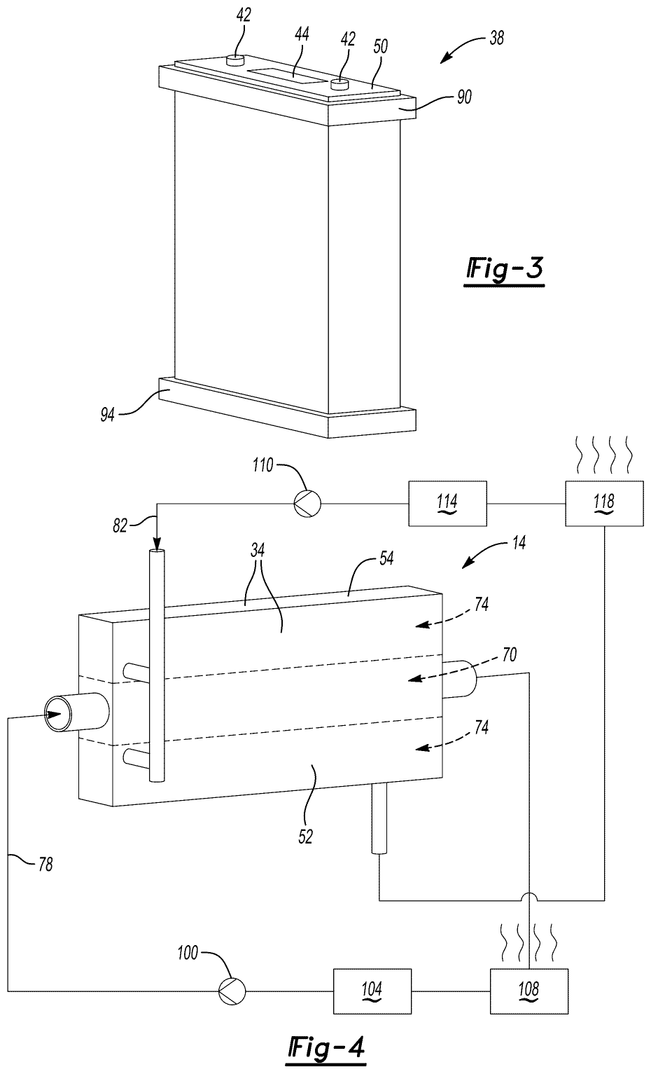

With reference now to FIGS. 2-4 and continuing reference to FIG. 1, the example traction battery pack 14 includes at least one first cell stack 30 and at least one second cell stack 32 housed within an enclosure assembly 34. The exemplary cell stacks 30, 32 each include a plurality of individual battery cells 38 that are stacked side-by-side relative to one another. The cell stacks 30, 32 can vary significantly in size, shape, and configuration within the scope of this disclosure.

Although only the two cell stacks 30, 32 are shown, the traction battery pack 14 could include any number of cell stacks having any number of individual battery cells 38. In other words, the disclosure is not limited to the specific configuration of battery cells 38 and cell stacks 30, 32 shown in the figures.

In the exemplary embodiment, the battery cells 38 are lithium-ion prismatic cells. However, battery cells having other geometries (pouch, cylindrical, etc.), chemistries (nickel-metal hydride, lead-acid, etc.), could be alternative utilized within the scope of this disclosure. The battery cells 38 are for supplying electrical power to various components of the electrified vehicle 10.

The battery cells 38 of the example battery pack 14 each include a pair of terminals 42 and a vent 44. For each of the example battery cells 38, the terminals 42 and the vent 44 are disposed on a common side 50 of the battery cell 38.

In the exemplary embodiment, the enclosure assembly 34 includes a lid 52 that secures to a tray 54 to provide an interior area 56 that houses the cell stacks 30, 32. The lid 52 can be bolted to the tray 54. The lid 52 can be connected to the tray 54 using fluid-tight connection techniques, such as adhesives or welds in other examples. The enclosure assembly 34 can vary significantly in size, shape, and configuration from the enclosure assembly 34 shown.

The battery pack 14 relies on an immersion thermal management system to manage thermal energy levels within the battery pack 14. The immersion thermal management system utilizes different types of coolant. One type of coolant utilized within the immersion thermal management system is appropriate for managing thermal energy levels of components that are configured as electrical conductors of the battery pack 14. Another type of coolant utilized within the immersion thermal management system is used to manage thermal energy levels of other components of the battery pack 14.

In this example, at least at the terminals 42 are conductive features of the battery pack 14. Other exemplary conductive features of the battery pack 14 could include busbars (not shown) coupled to the terminals 42.

The cell stacks 30, 32 are positioned within the interior area 56 such that that the terminals 42 and the vents 44 of the battery cells 38 in the first cell stack 30 face the terminals 42 and the vents 44 of the battery cells in the second cell stack 32. The cell stacks 30, 32, due to this orientation, can be considered side oriented cell stacks 30, 32.

The interior area 56 of the enclosure assembly 34 is separated into a first volume 70 and at least one second volume 74. Here, the example interior area 56 includes two second volumes 74 sandwiching the first volume 70.

The immersion thermal management system can, as necessary, circulate a first coolant 78 through the first volume. The first coolant 78 is a dielectric liquid. The immersion thermal management system can, as necessary, circulate a second coolant 82 through the second volumes 74.

The first volume 70 and the second volumes 74 are established such that the components of the battery pack 14 that are configured as electrical conductors are disposed within the first volume 70, not the second volumes 74. Thus, any electrically conducting components of the battery pack 14 are configured to be directly contacted by the first coolant 78. At least some of the electrically conducting components are submerged within the first coolant 78 that is within the first volume 70. Facing terminals 42 of the cells stacks 30, 32 toward each other facilitates accommodating the terminals 42 within the first volume 70.

The second coolant 82 within the second volume 74 is not the same as the first coolant 78. The first coolant 78 can be a dielectric liquid. The second coolant 82 may not be a dielectric liquid. The second coolant 82 could, for example, be a 50/50 mix of water and glycol. As the second coolant 82 is used to manage thermal energy levels of components within the second volume 74 that are not electrically conducting components, the second coolant 82 does not need to be a dielectric liquid.

A scaling system 86 is utilized to fluidly separate the first volume 70 from the second volumes 74 within the interior area 56. The first volume 70 is separate and distinct from the second volumes 74.

The sealing system 86 can keep the first coolant 78 contained within the first volume 70 within the battery pack 14, and can keep the second coolant 82 contained within the second volumes 74 when contained within the battery pack 14. The sealing system 86 blocks the first coolant 78 from entering the second volumes 74 and the second coolant 82 from entering the first volume 70.

The scaling system 86 includes, in this example, a plurality of first sealing rings 90 that circumscribe each individual battery cell 38 within the first cell stack 30, and a plurality of second sealing rings 92 that circumscribe each individual battery cell 38 within the second cell stack 32. The first sealing rings 90 fluidly separates the first volume 70 from the second volume 74 on a first side of the interior area 56. The second sealing rings 92 fluidly separates the first volume 70 from the second volume 74 on a second side of the interior area 56.

The sealing rings 90, 92 can be compressed and can seal interfaces between outer surfaces of the battery cells 38 and the enclosure assembly 34. Other sealing rings 94 can be placed in other areas to help to maintain gaps and spacing between the battery cells 38. The sealing rings 90, 92, 94 can be a compressible silicon material, for example.

The thermal management system incorporates a first pump 100, a first coolant supply 104, and a first thermal exchange device 108. The first pump 100 can be activated to circulate the first coolant 78 along a coolant loop passing through the first volume 70, first pump 100, first coolant supply 104, and the first thermal exchange device 108. When passing through the first volume 70, the first coolant 78 can take on thermal energy from components of the battery pack 14 within the first volume 70, including those components that are conductive such as the terminals 42.

After taking on thermal energy within the first volume 70, the first pump 100 circulates the first coolant 78 to the first thermal exchange device 108. At the first thermal exchange device 108, thermal energy can be released from the first coolant 78 to the air. The first coolant 78 can then be pumped back into the first coolant supply 104 and circulated back through the first volume 70 to remove additional thermal energy.

A control module (not shown) can be incorporated within the electrified vehicle 10 to control activation of the first pump 100. The control module could, for example, activate the first pump 100 only under certain conditions, such as when a sensor within the battery pack 14 detects temperature within the first volume 70 that has exceeded a threshold level.

The coolant system further includes a second pump 110, a second coolant supply 114, and a second thermal exchange device 118. The second pump 110 can be activated to circulate the second coolant 82 along another coolant loop through the second volumes 74, second pump 110, second coolant supply 114, and the second thermal exchange device 118. When passing through one of the second volume 74, the second coolant 82 can take on thermal energy from components of the battery pack 14 within that second volume 74.

After taking on thermal energy, the second pump 110 circulates the second coolant 82 to the second thermal exchange device 118. Thermal energy is released from the second coolant 82 at the second thermal exchange device 118. The second coolant can then be added to the second coolant supply 114 and, as required circulated back through the second volume 74 to remove additional thermal energy. Like the first pump 100, the control module can control activation of the second pump 110. When passing through one of the second volume 74, the second coolant 82 can impinge along the smaller sides of the battery cells 38 and then flow along the larger sides of the battery cells 38. Some of the second coolant 82 bypasses the second volume 74 and instead is directed through the cooling plate 40.

The second coolant 82 is introduced to second volumes 74 through respective inlets, which are, in this example, at a vertical top of the battery pack 14. The second coolant 82 exits each of the second volumes 74 at respective outlets, which are a vertical bottom of the battery pack 14. Vertical top and bottom are with reference to ground and an ordinary orientation of the battery pack 14 when installed within the vehicle 10. After being introduced to one of the second volumes 74, the second coolant 82 can flow down between the individual battery cells 38. The positioning of the inlets and outlets to the second volumes 74 helps to ensure that all the second coolant 82 travels substantially the same distance when flowing through one of the second volumes 74.

Referring again to the vents 44 of the battery cells 38, the vents 44 are positioned to open into the first volume 70 and into the first coolant 78 that is within the first volume 70. The first coolant 78 can be configured to be a coolant appropriate for receiving vent byproducts from the cells 38 that pass to the first volume 70 through vents 44 of the cells 38. These vent byproducts can, in some examples, include potentially electrically conductive particles and debris. Internal areas of the battery cells 38 can also be electrically conductive. In some examples, the first coolant 78 can be air.

As understood, one or more individual cells 38 can vent during a thermal event causing vent byproducts to be released from within that one or more battery cells 38 through the respective vents 44 into the first coolant 78. Since the first coolant 78 is, in this example, a dielectric liquid or air, the fluid potentially entering internal areas of the battery cells 38 through the vents 44 presents no issue with respect to electrical conductivity. Even if the first coolant 78 is not circulated through the first volume 70, venting into the first volume 70 helps to contain the first coolant 78.

While the first coolant 78 and the second coolant 82 remove thermal energy from the battery pack 14 in this example. In another example, the first coolant 78, the second coolant 82, or both can be used to add thermal energy (i.e., heat) the battery pack 14. The two coolant loops move perpendicularly to one another within the battery pack 14. The two coolant loops could be oriented differently in other examples.

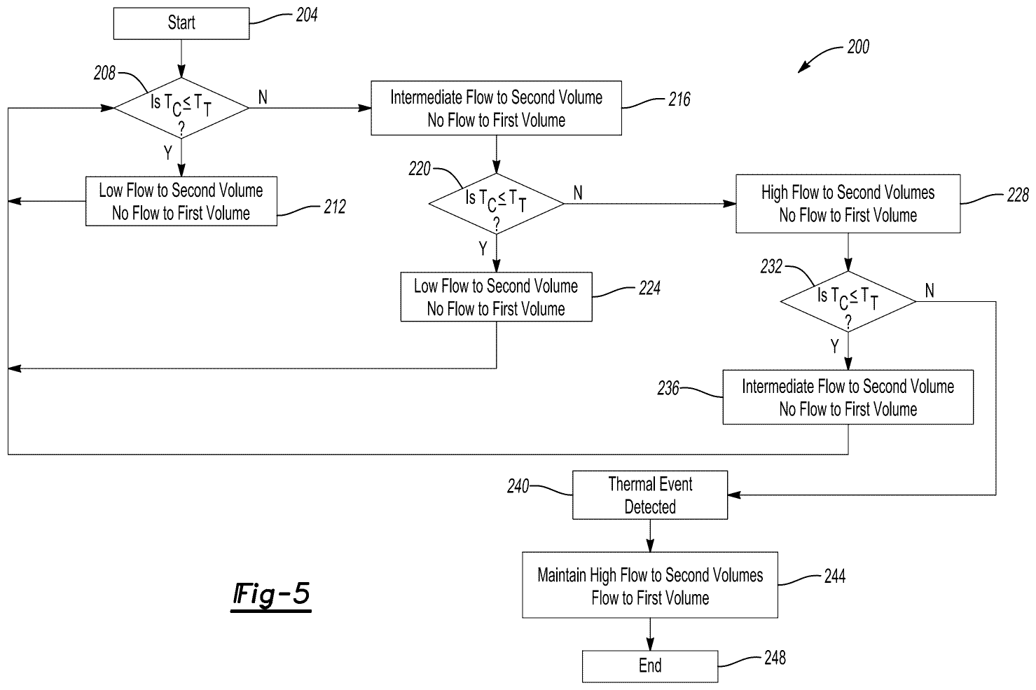

With reference to FIG. 5 and continuing reference to FIGS. 2-4, an example method 200 of managing thermal energy for the battery pack 14 begins at a step 204. Next, the method 200 moves to a step 208 where a temperature T_{C} of the second coolant 82 is compared to a temperature threshold T_{T}. The temperature T_{C} is a temperature of the second coolant 82 as the second coolant 82 exits the enclosure 99. A temperature sensor can be used to detect the temperature of the second coolant 82.

If the temperature T_{C} of the second coolant 82 is less than or equal to the temperature threshold T_{T}, the method 200 moves to the step 212 and controls the second pump 110 to circulate a relatively low flow of the second coolant 82 through the second volumes 74. The first pump 100 is not activated so that there is substantially no flow of the first coolant 78 through the first volume 70. The method 200 then returns to the step 208.

If, at the step 208, the temperature T_{C} of the second coolant 82 is greater than the temperature threshold T₁, the method 200 moves to the step 216, which controls the second pump 110 to circulate an intermediate flow of the second coolant 82 through the second volumes 74. The first pump 100 is not activated so that there is substantially no flow of the first coolant 78 through the first volume 70.

Next, the method 200 moves from the step 216 to a step 220 where the temperature T_{C} is again compared to the threshold temperature T_{T}. If the temperature T_{C} is less than the threshold temperature T_{T}, the method 200 moves to a step 224. At the step 224, the method 200 controls the second pump 110 to circulate a relatively low flow of the second coolant 82 through the second volumes 74. The first pump 100 is not activated so that there is substantially no flow of the first coolant 78 through the first volume 70. The method 200 then returns to the step 208.

If, at the step 220, the temperature T_{C} is greater than the threshold temperature T_{T}, the method 200 moves from the step 220 to a step 228, which activates the second pump 110 to provide a high flow of the second coolant 82 through the second volumes 74. The first pump 100 is still not activated so that there is substantially no flow of the first coolant 78 through the first volume 70.

Next, the method 200 moves from the step 228 to a step 232 where the temperature T_{C} is again compared to the threshold temperature T_{T}. If, at the step 232, the temperature T_{C} is less than the threshold temperature T_{T}, the method 200 moves to a step 236. At the step 236, the method 200 controls the second pump 110 to circulate an intermediate flow of the second coolant 82 through the second volumes 74. The first pump 100 is not activated so that there is substantially no flow of the first coolant 78 through the first volume 70. The method 200 then returns to the step 208.

If, at the step 232, the temperature T_{C} is greater than the threshold temperature T_{T}, the method 200 moves from the step 232 to a step 240, which identifies a thermal event within the battery pack 14. The method 200 moves from the step 240 to a step 244, which activates the second pump 110 to provide a high flow of the second coolant 82 through the second volumes 74, and activates the first pump 100 to provide a flow of the first coolant 78 through the first volume 70. The flow of the first coolant 78 can mix with vent byproducts vented from the battery cells 38 of the first cell stack 30, the second cell stack 32, or both. the method then ends at a step 248.

Features of disclosed examples include a battery pack that includes a thermal management system capable of circulating different types of coolant through the battery pack. This can facilitate using less of one type of coolant, such as less dielectric liquid, to manage thermal energy within an immersion thermal management system for a battery pack. Facing terminals of different cell stacks toward each other can further help to reduce dielectric liquid coolant that may be required.

The preceding description is exemplary rather than limiting in nature. Variations and modifications to the disclosed examples may become apparent to those skilled in the art that do not necessarily depart from the essence of this disclosure. Thus, the scope of protection given to this disclosure can only be determined by studying the following claims.

What is claimed is:

1. A traction battery pack assembly, comprising:
an enclosure assembly providing an interior;
a first cell stack housed within the interior, the first cell stack including a plurality of first battery cells having first terminals;
a second cell stack housed within the interior, the second cell stack including a plurality of second battery cells having second terminals;
a first coolant within the interior, the first coolant directly contacting the first terminals of the plurality of first battery cells within the first cell stack and second terminals of the plurality of second battery cells within the second cell stack; and
a second coolant that manages thermal energy within the interior, the second coolant a different type of coolant than the first coolant.

2. The traction battery pack assembly of claim 1, wherein the first coolant is less conductive than the second coolant.

3. The traction battery pack assembly of claim 2, wherein the first terminals and the second terminals face each other within the interior.

4. The traction battery pack assembly of claim 2, wherein the first coolant is a dielectric coolant.

5. The traction battery pack assembly of claim 1, wherein the first coolant is a liquid coolant, wherein the second coolant is a liquid coolant.

6. The traction battery pack assembly of claim 1, wherein the first coolant is air and the second coolant is a liquid coolant.

7. The traction battery pack assembly of claim 1, further comprising a sealing system within the interior, the sealing system separating the interior into a first volume that contains the first coolant and at least one different, second volume that contains the second coolant.

8. The traction battery pack assembly of claim 7, wherein the plurality of first battery cells and the plurality of second battery cells are configured to vent into the first volume.

9. The traction battery pack assembly of claim 7, wherein the sealing system includes at least one first sealing ring circumscribing one or more of the first battery cells and at least one second sealing ring circumscribing one or more of the second battery cells.

10. The traction battery pack assembly of claim 9, wherein the at least one first sealing ring seals an interface between a surface of at least one of the first battery cells and the enclosure assembly.

11. A method of managing thermal energy levels within a battery pack, comprising:
positioning first terminals of at least one first cell stack within a first volume that is within an interior of a battery pack;
positioning second terminals of at least one second cell stack within the first volume that is within the interior of the battery pack;
circulating a first coolant through the first volume to manage thermal energy; and
circulating a second coolant through at least one second volume within the interior of the battery pack, the second coolant a different type of coolant than the first coolant.

12. The method of claim 11, wherein the first coolant is less conductive than the second coolant.

13. The method of claim 11, wherein the first coolant is a liquid dielectric.

14. The method of claim 11, wherein the first coolant is air.

15. The method of claim 11, further comprising sealing the first volume from the at least one second volume to block the first coolant from entering the at least one second volume, and to block the second coolant from entering the first volume.

16. The method of claim 11, wherein the first terminals and the second terminals face each other within the interior of the battery pack.

17. The method of claim 11, wherein the first volume is separate and distinct from the at least one second volume.

18. The method of claim 11, wherein components of the battery pack that are configured as electrical conductors are disposed within the first volume.

19. The method of claim 11, further comprising venting the at least one first cell stack and the at least one second cell stack into the first volume.
